(19) United States
(12) Patent Application Publication
(10) Pub. No.: US 2025/0163273 A1
(43) Pub. Date: May 22, 2025

(54) METHOD FOR PRODUCING AN ASPHALT EMULSION COMPOSITION CONTAINING A FUNCTIONALIZED POLYESTER RESIN

(71) Applicant: KAO CORPORATION, Tokyo (JP)

(72) Inventors: Machiko IE-KONO, High Point, NC (US); Mohand MELBOUCI, High Point, NC (US); Martin THOMPSON, High Point, NC (US); Eiji SHIRAI, Tokyo (JP)

(73) Assignee: KAO CORPORATION, Tokyo (JP)

(21) Appl. No.: 18/954,640

(22) Filed: Nov. 21, 2024

Related U.S. Application Data
(60) Provisional application No. 63/601,778, filed on Nov. 22, 2023.

(51) Int. Cl. C08L 95/00

(52) U.S. Cl. CPC C08L 95/005

(57) ABSTRACT

The present invention relates to: a method for producing an asphalt composition that contains a matrix part containing an asphalt and a domain part containing a polyester, the method including melting the asphalt and the polyester to produce a molten product, and applying a breaking force to the molten product; and an asphalt composition containing a matrix part and a domain part, the matrix part containing an asphalt, the domain part containing a polyester, the domain part having a number average longest diameter of ≤20 μm.

### FIELD OF THE INVENTION

The present invention relates to a method for producing an asphalt emulsion composition comprising a functionalized polyester resin, and asphalt composition.

### BACKGROUND OF THE INVENTION

Asphalt pavement using an asphalt mixture has been used for paving highways, driveways, parking spaces, cargo yards, sidewalks, etc. because of relatively easy construction and a short period of time from beginning of paving works to opening to traffic. Since a road surface is formed from an asphalt mixture in which aggregates are bonded via an asphalt binder in the asphalt pavement mixture, the paved road has a good hardness and durability. However, slight surface aggregate separation (raveling) and crack generation occur in the surface course of asphalt pavement due to degradation. The lifetime of the asphalt pavement can be prolonged by conducting regular maintenance to prevent severe deformation (ruts), cracks, aggregate separation, potholes, etc. that would otherwise require re-surfacing. An asphalt emulsion is used for such regular maintenance and many other applications. It is useful for stabilizing the pavement surface, for example, by using various surface treatments: slurry sealing, micosurfacing, chip sealing, fog sealing, recycling (cold-central plant, cold in-place). An asphalt emulsion is basically produced by emulsifying an asphalt as an oil phase and water and an emulsifier as an aqueous phase. For the purpose of enhancing the durability of the pavement surfaces containing the asphalt emulsion, a resin emulsion, such as SBR, and the like may be used in production of the asphalt emulsion.

JP 2022-112510 A (PTL 1) discloses a method for producing an asphalt emulsion superior in weather resistance, a method for producing an asphalt emulsion, the method including a step 1 of melt-mixing an asphalt and a polyester to produce an asphalt mixture and a step 2 of adding an aqueous medium and a surfactant to the asphalt mixture obtained in the step 1, followed by mixing.

### SUMMARY OF THE INVENTION

The present invention relates to a method for producing an asphalt composition that contains a matrix part containing an asphalt binder and a domain part containing a polyester, the method including melting the asphalt and the polyester to produce a molten product and applying a breaking force to the molten product.

### DETAILED DESCRIPTION OF THE INVENTION

The asphalt emulsion disclosed in PTL 1 can provide asphalt pavement having a superior weather resistance. However, there is still a room for improvement in the fuel resistance and thermal stability.

The present invention relates to an asphalt emulsion composition comprising a functionalized polyester resin for achieving an asphalt pavement with superior thermal stability and superior fuel resistance and a method for producing the same.

The present invention relates to the following (1) and (2).

(1) A method for producing an asphalt emulsion composition that contains a matrix part containing an asphalt and a domain part containing a polyester, the method comprising melting the polyester in the asphalt to produce an asphalt/polyester mixture, and applying a breaking force to the asphalt/polyester mixture.
(2) An asphalt composition comprising a matrix part and a domain part, the matrix part containing an asphalt, the domain part containing a polyester, the domain part having a number average longest diameter of ≤20 km.

### [Method for Producing Asphalt Composition]

A method for producing an asphalt composition according to the present invention includes melting the polyester in the asphalt and applying a breaking force to the resulting mixture.

The present inventors have found that an asphalt emulsion that contains an asphalt composition obtained by the production method according to the present invention has a superior thermal stability and that asphalt pavement constructed with the asphalt emulsion has a superior fuel resistance.

The detailed mechanism of achieving the effect of the present invention is not clear, but is partially considered as follows.

As described in PTL 1, an anchor type impeller has conventionally been used in producing an asphalt composition by dispersing a polyester in an asphalt binder. However, in such a dispersion method, a high polar polyester is not easily compatibilized to a low polar asphalt, and the thermal stability of an asphalt emulsion produced with the resulting asphalt composition and the fuel resistance of the asphalt pavement constructed with the asphalt emulsion are sometimes not sufficient.

The method for producing an asphalt composition according to the present invention, a breaking force is applied to a molten mixture of a polyester in asphalt to disperse the polyester in the asphalt, whereby an asphalt composition having a homogenised and uniform structure in which a domain part containing the polyester is highly dispersed in a matrix part containing the asphalt is produced. It is understood that, when the asphalt composition obtained by this production method is dispersed in an aqueous medium, the highly dispersed polyester adheres to the surface of the asphalt to thereby form a pseudo-core-shell structure in which the asphalt is covered with the polyester which has a higher glass transition temperature and is more hydrophilic than the asphalt, whereby an asphalt emulsion having a superior thermal stability is produced. It is also understood that, in the asphalt pavement constructed with the resulting asphalt emulsion, since the asphalt is covered with the hydrophilic polyester, the loss of the asphalt due to fuel damage compounds is suppressed, whereby the asphalt pavement exhibits a superior fuel resistance.

As described above, it is considered that an asphalt emulsion containing an asphalt composition obtained by a production method according to the present invention has a superior thermal stability and that asphalt pavement constructed with the asphalt emulsion has a superior thermal resistance.

Definitions and the like of various terms in this description will be shown below.

In a polyester, the “alcohol component-derived structural unit” means a structure obtained by eliminating a hydrogen atom from a hydroxy group of the alcohol component, and the “carboxylic acid component-derived structural unit” means a structure obtained by eliminating a hydroxy group from a carboxylic group of the carboxylic acid component.

The “carboxylic acid component” includes not only the carboxylic acid but also the anhydride which decomposes in a reaction to produce the acid and an alkyl ester of the carboxylic acid (the number of carbon atoms of the alkyl group is, for example, C1 to C3). When the carboxylic acid component is an alkyl ester of the carboxylic acid, the number of carbon atoms of the carboxylic acid does not include the number of carbon atoms of the alkyl group that is an alcohol residue of the ester.

The “≤A” and “≥B” mean “A or less” and “B or more”, respectively.

### <Asphalt>

Various asphalts can be used. The asphalt is selected based on some factors, such as a specific project requirement, weather conditions in the area, and the intended application. The asphalt is generally characterized by the performance grade PG (regulated according to AASHTO M 320) binder within but not limited to the following range: PG 52-XX to PG 76-XX.

### <Polyester>

In a production method according to an aspect of the present invention, the polyester is a polycondensate of an alcohol component and a carboxylic acid component, containing a structural unit derived from the alcohol component and a structural unit derived from the carboxylic acid component.

Properties and the like of the alcohol component, the carboxylic acid component, and the polyester will be described below.

### (Alcohol Component)

Examples of the alcohol component include an aliphatic diol, an alicyclic diol, an aromatic diol, and a trihydric or higher polyhydric alcohol. Each of the alcohol components can be used alone or two or more thereof can be used in combination.

The aliphatic diol is preferably a linear or branched aliphatic diol having a main chain having ≥2 and ≤12 carbon atoms, and more preferably a linear or branched aliphatic diol having a main chain having ≥2 and ≤8 carbon atoms.

The aliphatic diol is preferably a saturated aliphatic diol.

Specific examples of the aliphatic diol include ethylene glycol, 1,2-propanediol, 1,3-propanediol, 1,3-butanediol, 1,4-butanediol, 1,4-butenediol, 1,5-pentanediol, 1,6-hexanediol, neopentyl glycol, 1,10-decanediol, and 1,12-dodecanediol.

Examples of the alicyclic diol include hydrogenated bisphenol A (2,2-bis(4-hydroxycyclohexyl)propane), an alkylene oxide adduct of hydrogenated bisphenol A, cyclohexanediol, and cyclohexanedimethanol.

Examples of the aromatic diol include bisphenol A (2,2-bis(4-hydroxyphenyl)propane) and an alkylene oxide adduct of bisphenol A. An example of the alkylene oxide adduct of bisphenol A is an alkylene oxide adduct of bisphenol A represented by the following formula (I).

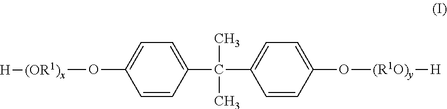

In the formula (I), OR¹ and RIO are an alkylene oxide, R¹ is an alkylene group having 2 or 3 carbon atoms, x and y represent a positive number indicating an average number of moles of alkylene oxides added, and the sum of x and y is preferably ≥1, more preferably ≥1.5, and preferably ≤16, more preferably ≤8, further preferably ≤4.

Examples of the alkylene oxide adduct of bisphenol A represented by the formula (I) include a propylene oxide adduct of bisphenol A and an ethylene oxide adduct of bisphenol A. Each of the alkylene oxide adducts of bisphenol A can be used alone or two or more thereof can be used in combination.

The trihydric or higher polyhydric alcohol is preferably a trihydric alcohol. Examples of the trihydric or higher polyhydric alcohol include glycerol, pentaerythritol, trimethylolpropane, and sorbitol.

From the viewpoint of controlling properties, the alcohol component can further contain a monohydric aliphatic alcohol. Examples of the monohydric aliphatic alcohol include lauryl alcohol, myristyl alcohol, palmityl alcohol, and stearyl alcohol. Each of the monohydric aliphatic alcohols can be used alone or two or more thereof can be used in combination.

In a preferred aspect of the polyester, from the viewpoints of the thermal stability of the asphalt emulsion and the fuel resistance of asphalt pavement, the content of the alkylene oxide adduct of bisphenol A in the alcohol component is preferably ≥20% by mass, further preferably ≥30% by mass, and preferably ≤80% by mass.

### (Carboxylic Acid Component)

Examples of the carboxylic acid component include an aliphatic dicarboxylic acid, an aromatic dicarboxylic acid, and a tribasic or higher and hexabasic or lower polybasic carboxylic acid. Each of the carboxylic acid components can be used alone or two or more thereof can be used in combination.

Examples of the aliphatic dicarboxylic acid include aliphatic dicarboxylic acids with a main chain having preferably ≥4 and preferably ≤14 carbon atoms, such as fumaric acid, maleic acid, oxalic acid, malonic acid, citraconic acid, itaconic acid, glutaconic acid, succinic acid, adipic acid, suberic acid, azelaic acid, sebacic acid, dodecanedioic acid, a succinic acid substituted with an alkyl group having ≥1 and ≤20 carbon atoms or an alkenyl group having ≥2 and ≤20 carbon atoms, anhydrides thereof, and alkyl esters thereof (the number of carbon atoms of the alkyl group is, for example, ≥1 and ≤3). Examples of the substituted succinic acid include dedocylsuccinic acid, dodecenylsuccinic acid, and octenylsuccinic acid.

Examples of the aromatic dicarboxylic acids include phthalic acid, terephthalic acid, isophthalic acid, naphthalene dicarboxylic acid, anhydrides thereof, and alkyl esters thereof (the number of carbon atoms of the alkyl group is, for example, ≥1 and ≤3). Among the aromatic dicarboxylic acids, from the viewpoints of the thermal stability of asphalt emulsion and the fuel resistance of asphalt pavement, isophthalic acid and terephthalic acid are preferred, and terephthalic acid is more preferred.

The tribasic or higher and hexabasic or lower polybasic carboxylic acid is preferably a tribasic carboxylic acid. Examples of the tribasic or higher and hexabasic or lower polybasic carboxylic acid include trimellitic acid, 2,5,7-naphthalene tricarboxylic acid, pyromellitic acid, and acid anhydrides thereof.

From the viewpoint of controlling the properties, the carboxylic acid component can further contain a monobasic carboxylic acid. Examples of the monobasic carboxylic acid include aliphatic monobasic carboxylic acids having ≥12 and ≤20 carbon atoms, such as lauric acid, myristic acid, palmitic acid, stearic acid, and an alkyl (having ≥1 and ≤3 carbon atoms) ester of the acids, and benzoic acid. Each of the monobasic carboxylic acids can be used alone or two or more thereof can be used in combination.

### (Polyethylene Terephthalate-Derived Structural Unit)

The polyester can contain an ethylene glycol-derived structural unit and a terephthalic acid-derived structural unit that are derived from polyethylene terephthalate (PET). The polyethylene terephthalate may contain, besides the ethylene glycol-derived structural unit and the terephthalic acid-derived structural unit, a small amount of butanediol, isophthalic acid, or other components. The polyethylene terephthalate is preferably a collected polyethylene terephthalate.

In a preferred aspect of the polyester, from the viewpoints of the thermal stability of the asphalt emulsion and the fuel resistance of an asphalt pavement, the content of the alkylene oxide adduct of bisphenol A as an alcohol relative to the polyester is preferably ≥20% by mass, further preferably ≥30% by mass, and preferably ≤80% by mass.

### (Hydrocarbon Wax Having at Least One of Hydroxy Group and Carboxy Group)

In the polyester, a hydrocarbon wax having at least one of a hydroxy group and a carboxy group may be used as an alcohol component and/or a carboxylic acid component.

Examples of the hydrocarbon wax having a hydroxy group include those obtained by modifying a hydrocarbon wax, such as paraffin wax, Fischer Tropsch wax, microcrystalline wax, and polyethylene wax by oxidation treatment. Examples of commercial products of the hydrocarbon wax having a hydroxy group include “UNILIN 700”, “UNILIN 425”, and “UNILIN 550” (all manufactured by Baker Petrolite).

The hydroxyl value of the hydrocarbon wax having a hydroxy group is preferably ≥40 mgKOH/g, more preferably ≥55 mgKOH/g, further preferably ≥65 mgKOH/g, and preferably ≤180 mgKOH/g, more preferably ≤150 mgKOH/g, further preferably ≤120 mgKOH/g, furthermore preferably ≤110 mgKOH/g.

The hydroxyl value of the hydrocarbon wax having a hydroxy group can be measured by a neutralization titration method described in JIS K0070:1992. Alternatively, as the hydroxyl value of the hydrocarbon wax having a hydroxy group, a value shown in a product data sheet may be used.

Examples of the hydrocarbon wax having a carboxy group include those obtained by modifying the hydrocarbon waxes mentioned above with an acid. Examples of commercial products of the hydrocarbon wax having a carboxy group include a maleic anhydride-modified ethylene-propylene copolymer “Hi-WAX 1105A” (manufactured by Mitsui Chemicals, Inc.) The acid value of a hydrocarbon wax having a carboxy group is preferably ≥1 mgKOH/g, more preferably ≥5 mgKOH/g, further preferably ≥10 mgKOH/g, and preferably ≤30 mgKOH/g, more preferably ≤25 mgKOH/g, further preferably ≤20 mgKOH/g.

The acid value of the hydrocarbon wax having a carboxy group can be measured by a neutralization titration method described in JIS K0070:1992. Alternatively, as the acid value of the hydrocarbon wax having a carboxy group, a value shown in a catalog may be used.

Examples of commercial products of the hydrocarbon wax having a hydroxy group and a carboxy group include “Paracol 6420”, “Paracol 6470”, and “Paracol 6490” (all manufactured by NIPPON SEIRO CO., LTD.).

Preferred ranges of the hydroxyl value and the acid value of the hydrocarbon wax having a hydroxy group and a carboxy group are the same as those of the hydroxyl value of the hydrocarbon wax having a hydroxy group and the acid value of the hydrocarbon wax having a carboxy group.

The sum of the hydroxyl value and the acid value of the hydrocarbon wax having a hydroxy group and a carboxy group is, from the viewpoints of the thermal stability of asphalt emulsion and the fuel resistance of asphalt pavement, preferably ≥35 mgKOH/g, more preferably ≥60 mgKOH/g, further preferably ≥90 mgKOH/g, and preferably ≤210 mgKOH/g, more preferably ≤175 mgKOH/g, further preferably ≤140 mgKOH/g.

The melting point of the hydrocarbon wax having at least one of a hydroxy group and a carboxy group is preferably ≥60° C., more preferably ≥65° C., further preferably ≥70° C., and preferably ≤100° C., more preferably ≤90° C.

In the polyester containing a structural unit derived from a hydrocarbon wax having at least one of a hydroxy group and a carboxy group, the content of the structural unit derived from a hydrocarbon wax having at least one of a hydroxy group and a carboxy group is preferably ≥1% by mass, more preferably ≥2% by mass, further preferably ≥3% by mass, and preferably ≤10% by mass, more preferably ≤8% by mass, further preferably ≤6% by mass.

The polyester may be a polyester modified to the extent that the characteristics thereof are not substantially impaired. Specific examples of the modified polyester include polyesters grafted or blocked with phenol, urethane, epoxy, or the like by a method described in JP11-133668A, JP10-239903A, JP8-20636A, and the like. A preferred example of the modified polyester is a urethane-modified polyester obtained by urethane-extending a polyester with a polyisocyanate compound.

In addition, the polyester may be a polyester that is composited to have a polyester segment and an addition polymer segment (hereinafter also referred to as “composite polyester”).

An example of the polyester segment of the composite polyester is a polycondensate of such an alcohol component and a carboxylic acid component as described above. An example of the addition polymer segment of the composite polyester is an addition polymer of a raw monomer having a carbon-carbon unsaturated bond containing a styrene compound.

The composite polyester preferably has a polyester segment, an addition polymer segment, and a structural unit that can be covalently bonded to both the segments. Examples of the structural unit that can be covalently bonded to a polyester segment include a hydroxy group, a carboxy group, an epoxy group, a primary amino group, a secondary amino group, and an ester group. An example of the structural unit that can be covalently bonded to an addition polymer segment is a carbon-carbon unsaturated bond (ethylenically unsaturated bond).

An example of the styrene compound is an unsubstituted or substituted styrene. Examples of the substituent substituted on styrene include an alkyl group having 1 or more and 5 or less carbon atoms, a halogen atom, an alkoxy group having 1 or more and 5 or less carbon atoms, and a sulfonate group or a salt thereof.

Examples of the styrene compound include styrene, methylstyrene, α-methylstyrene, β-methylstyrene, tert-butylstyrene, chlorostyrene, chloromethylstyrene, methoxystyrene, and styrenesulfonic acid or a salt thereof. Among them, styrene is preferred.

In the raw monomers of the addition polymer segment, the content of the styrene compound is preferably 40% by mass or more, more preferably 50% by mass or more, further preferably 55% by mass or more, and preferably 95% by mass or less, more preferably 90% by mass or less, further preferably 85% by mass or less.

Examples of the raw monomer other than the styrene compound include (meth)acrylate esters, such as an alkyl (meth)acrylate, benzyl (meth)acrylate, and dimethylaminoethyl (meth)acrylate; olefins, such as ethylene, propylene, and butadiene; a halovinyl, such as vinyl chloride; vinyl esters, such as vinyl acetate and vinyl propionate; a vinyl ether, such as methyl vinyl ether; a halogenated vinylidene, such as vinylidene chloride; and an N-vinyl compound, such as N-vinyl pyrrolidone. Among them, an alkyl (meth)acrylate is preferred.

The number of carbon atoms of the alkyl group in the alkyl (meth)acrylate is preferably ≥1, more preferably ≥2, further preferably ≥3, and preferably ≤24, more preferably ≤22, further preferably ≤20.

Examples of the alkyl (meth)acrylate include methyl (meth)acrylate, ethyl (meth)acrylate, (iso)propyl (meth)acrylate, (iso- or tert-)butyl (meth)acrylate, (iso)amyl (meth)acrylate, cyclohexyl (meth)acrylate, 2-ethylhexyl (meth)acrylate, (iso)octyl (meth)acrylate, (iso)decyl (meth)acrylate, (iso)dodecyl (meth)acrylate, (iso)palmityl (meth)acrylate, (iso)stearyl (meth)acrylate, and (iso)behenyl (meth)acrylate. The alkyl (meth)acrylate is preferably an ester of (meth)acrylic acid and a branched alkyl alcohol, and more preferably 2-ethylhexyl (meth)acrylate, stearyl (meth)acrylate, and butyl (meth)acrylate.

In the raw monomers of the addition polymer segment, the content of the (meth)acrylate ester is preferably ≥5% by mass, more preferably ≥10% by mass, further preferably ≥15% by mass, and preferably ≤60% by mass, more preferably ≤50% by mass, further preferably ≤45% by mass.

In the raw monomers of the addition polymer segment, the total amount of the styrene compound and the (meth)acrylate ester is preferably ≥80% by mass, more preferably 90% by mass, further preferably ≥95% by mass, further preferably 100% by mass.

The composite polyester preferably has a structural unit derived from a bireactive monomer bonded to a polyester segment and an addition polymer segment via a covalent bond.

The “bireactive monomer-derived structural unit” means a unit obtained by a reaction of a functional group and an addition polymerizable group of the bireactive monomer.

Examples of the addition polymerizable group include a carbon-carbon unsaturated bond (ethylenically unsaturated bond).

An example of the bireactive monomer is an addition polymerizable monomer having in the molecule at least one functional group selected from a hydroxy group, a carboxy group, an epoxy group, a primary amino group, a secondary amino group, and an ester group. Among them, from the viewpoint of the reactivity, an addition polymerizable monomer having at least one functional group selected from a hydroxy group and a carboxy group is preferred, and an addition polymerizable monomer having a carboxy group and an addition polymerizable monomer having an ester group are more preferred.

Examples of the addition polymerizable monomer having a carboxy group include (meth)acrylic acid, 2-methyl-3-butenoic acid, and 4-pentenoic acid. Among them, from the viewpoint of the reactivities of both a polycondensation reaction and an addition polymerization reaction, (meth)acrylic acid is preferred, and acrylic acid is more preferred.

Examples of the addition polymerizable monomer having an ester group include esters of acrylic acid, 2-methyl-3-butenoic acid, 4-pentenoic acid, and the like. A part or all of the addition polymerizable monomer having an ester group undergoes a transesterification reaction with an alcohol component contained in the polyester segment to thereby form a covalent bond to the polyester segment, and a carbon-carbon unsaturated bond in the addition polymerizable monomer having an ester group undergoes an addition polymerization reaction with the raw monomer of the addition polymer segment to thereby form a covalent bond to the addition polymer segment. The residue of the addition polymerizable monomer having an ester group which has not undergone the transesterification reaction with the alcohol component is a raw monomer of the addition polymer segment.

Thus, among the addition polymerizable monomers having an ester group, from the viewpoint of the reactivities of both the transesterification reaction and the addition polymerization reaction, the alkyl acrylate that is mentioned as the raw monomer of the addition polymer segment in which the alkyl group is derived from a primary alcohol is preferred, and butyl acrylate is more preferred.

When the bireactive monomer is an addition polymerizable monomer having a carboxy group, the amount of the bireactive monomer-derived structural unit relative to 100 parts by mole of the alcohol component of the polyester segment is preferably ≥1 part by mole, more preferably ≥2 parts by mole, further preferably ≥2.5 parts by mole, and preferably ≤15 parts by mole, more preferably ≤10 parts by mole, further preferably ≤5 parts by mole.

### (Method for Producing Polyester)

The method for producing the polyester is not particularly limited, but, for example, the polyester may be produced by a method including subjecting an alcohol component and a carboxylic acid component to polycondensation. When the polyester is a composite polyester, the polyester may be produced by a method including subjecting the alcohol component and the carboxylic acid component to polycondensation and subjecting a raw monomer of an addition polymer segment and a bireactive monomer to addition polymerization.

Subjecting the raw monomer of the addition polymer segment and the bireactive monomer to addition polymerization may be performed after subjecting the alcohol component and the carboxylic acid component to polycondensation, subjecting the alcohol component and the carboxylic acid component to polycondensation may be performed after subjecting the raw monomer of the addition polymer segment and the bireactive monomer to addition polymerization, or subjecting the alcohol component and the carboxylic acid component to polycondensation and subjecting the raw monomer of the addition polymer segment and the bireactive monomer to addition polymerization may be performed at the same time.

In a preferred method, a part of the carboxylic acid component is subjected to a polycondensation reaction in subjecting the alcohol component and the carboxylic acid component to polycondensation, followed by subjecting the raw monomer of the addition polymer segment and the bireactive monomer to addition polymerization, and then, the residue of the carboxylic acid component is added to the polymerization system to further promote the polycondensation reaction of subjecting the alcohol component and the carboxylic acid component to polycondensation and the polycondensation reaction with the bireactive monomer or a carboxy group of a bireactive monomer-derived structural unit.

When the polyester used in the present invention contains a structural unit derived from polyethylene terephthalate-derived ethylene glycol and a structural unit derived from polyethylene terephthalate-derived terephthalic acid, the amount of polyethylene terephthalate present in the raw materials is, in the total amount of the polyethylene terephthalate, the alcohol component, and the carboxylic acid component, preferably ≥5% by mass, more preferably ≥10% by mass, further preferably ≥30% by mass, and preferably ≤80% by mass, more preferably ≤70% by mass, further preferably ≤60% by mass.

By adding polyethylene terephthalate in the polycondensation reaction of the alcohol component and the carboxylic acid component, a transesterification reaction occurs, and a polyester in which the structural unit of the polyethylene terephthalate is taken in the alcohol component-derived structural unit and the carboxylic acid component-derived structural unit can be obtained. The polyethylene terephthalate may be present from the beginning of the polycondensation reaction or may be added to the reaction system in the course of the polycondensation reaction.

In the polycondensation reaction, from the viewpoint of the reaction rate, an esterification catalyst can be used. An example of the esterification catalyst is a tin (II) compound having no Sn-C bond, such as tin (II) di(2-ethylhexanoate). The amount of the esterification catalyst used is, from the viewpoint of the reaction rate, relative to 100 parts by mass of the total amount of the polyethylene terephthalate, the alcohol component, and the carboxylic acid component, preferably ≥0.01 part by mass, more preferably ≥0.1 part by mass, further preferably ≥0.2 parts by mass, and preferably ≤1.5 parts by mass, more preferably ≤1.0 parts by mass, further preferably ≤0.6 parts by mass.

In the polycondensation reaction, in addition to the esterification catalyst, a promoter can be used. An example of the promoter is a pyrogallol compound, such as gallic acid. The amount of the promoter used is, relative to 100 parts by mass of the total amount of the alcohol component and the carboxylic acid component, preferably ≥0.001 part by mass, more preferably ≥0.005 parts by mass, further preferably ≥0.01 part by mass, and preferably ≤0.15 parts by mass, more preferably ≤0.10 parts by mass, further preferably ≤0.06 parts by mass.

When a monomer having an unsaturated bond, such as fumaric acid, is used in the polycondensation reaction, a radical polymerization inhibitor may be used, as required, in an amount of preferably ≥0.001 part by mass and ≤0.5 parts by mass relative to 100 parts by mass of the total amount of the alcohol component and the carboxylic acid component. Examples of the radical polymerization inhibitor include 4-tert-butylcatechol.

The temperature in the polycondensation reaction is preferably ≥120° C., more preferably ≥160° C., further preferably ≥180° C., and preferably ≤260° C., more preferably ≤250° C.

Examples of a radical polymerization initiator for the addition polymerization in subjecting the raw monomer of the addition polymer segment and the bireactive monomer to addition polymerization include a peroxide, such as di-tert-butylperoxide, a persulfate salt, such as sodium persulfate, and an azo compound, such as 2,2′-azobis(2,4-dimethylvaleronitrile).

The amount of the radical polymerization initiator used relative to 100 parts by mas of the raw monomer of the addition polymer segment is preferably ≥1 part by mass and ≤20 parts by mass.

The temperature in the addition polymerization is preferably ≥110° C., more preferably ≥130° C., and preferably ≤230° C., more preferably ≤220° C., further preferably ≤210° C.

### (Properties of Polyester)

The softening point of the polyester is, from the viewpoints of the thermal stability of asphalt emulsion and the fuel resistance of asphalt pavement, preferably ≥80° C., more preferably ≥90° C., and preferably ≤140° C., more preferably ≤130° C., further preferably ≤125° C.

The glass transition temperature of the polyester is, from the viewpoints of the thermal stability of asphalt emulsion and the fuel resistance of asphalt pavement, preferably ≥40° C. or higher, more preferably ≥45° C., further preferably ≥50° C., and preferably ≤90° C., more preferably ≤80° C., further preferably ≤70° C.

The acid value of the polyester is, from the viewpoints of the thermal stability of asphalt emulsion and the fuel resistance of asphalt pavement, preferably ≥1 mgKOH/g, more preferably ≥3 mgKOH/g, further preferably ≥5 mgKOH/g, and preferably ≤50 mgKOH/g, more preferably ≤40 mgKOH/g, further preferably ≤30 mgKOH/g.

The hydroxyl value of the polyester is, from the viewpoints of the thermal stability of asphalt emulsion and the fuel resistance of asphalt pavement, preferably ≥5 mgKOH/g, more preferably ≥10 mgKOH/g, further preferably ≥15 mgKOH/g, and preferably ≤50 mgKOH/g, more preferably ≤40 mgKOH/g, further preferably ≤35 mgKOH/g.

The number average molecular weight Mn of the polyester is, from the viewpoints of the thermal stability of asphalt emulsion and the fuel resistance of asphalt pavement, preferably ≥1,500, more preferably ≥1,800, further preferably ≥2,000, and preferably ≤9,000, more preferably ≤7,000, further preferably ≤5,000.

The weight average molecular weight Mw of the polyester is, from the viewpoints of the thermal stability of asphalt emulsion and the fuel resistance of asphalt pavement, preferably ≥5,000, more preferably ≥6,000, further preferably ≥7,000, and preferably ≤100,000, more preferably ≤80,000, further preferably ≤50,000.

The softening point, the glass transition temperature, the acid value, the hydroxyl value, the number average molecular weight Mn, and the weight average molecular weight Mw of the polyester can be measured by methods described in the section of Examples. The softening point, the glass transition temperature, the acid value, the hydroxyl value, the number average molecular weight Mn, and the weight average molecular weight Mw can be controlled by the composition of the raw monomers, the molecular weight, the amount of the catalyst, or the reaction conditions.

### [Producing Molten Mixture of Asphalt and Polyester]

Melting a polyester in an asphalt to produce a molten mixture is performed, for example, by adding a polyester to a molten asphalt and mixing the polyester and the asphalt. Melting the polyester in the asphalt to produce the molten mixture may be performed simultaneously with applying a breaking force to the mixture described later.

The molten mixture may contain other components, such as waxes, oils and surfactants. Examples of the cationic surfactant include a mineral acid salt and a lower carboxylic acid salt of an amine, such as an alkylamine, an alkylpolyamine, an amideamine, and an alkylimidazoline, and a quaternary ammonium salt.

Mixing of the asphalt and the polyester is performed by stirring and mixing the components with a generally used mixer until the polyester is uniformly dispersed. Examples of the generally used mixer include a high-speed homogenizer, a dissolver, a paddle mixer, a ribbon mixer, a screw mixer, a planetary mixer, a vacuum reverse-flow mixer, a roll mill, and a twin-screw extruder.

The temperature in mixing the asphalt and the polyester is, from the viewpoint of uniformly dispersing the polyester in the asphalt, the softening point of the polyester or higher, preferably 140° C., more preferably ≥150° C., and preferably ≤200° C., more preferably ≤190° C., further preferably ≤180° C.

The time for mixing the asphalt and the polyester is not particularly limited, but, from the viewpoint of efficient/uniform dispersing the polyester in the asphalt, preferably ≥3 minutes, more preferably 10 minutes, further preferably 30 minutes, furthermore preferably ≥1 hour, and preferably ≤8 hours, more preferably 56 hours, further preferably 55 hours, furthermore preferably 54 hours.

The mass ratio of the polyester to the asphalt (polyester/asphalt) is, from the viewpoints of the thermal stability of asphalt emulsion and the fuel resistance of asphalt pavement, preferably 0.5/100, more preferably 1/100, further preferably 2/100, and preferably 515/100, more preferably 510/100, further preferably ≤5/100.

### [Applying Breaking Force to Molten Mixture]

By performing of applying a breaking force to a domain part containing the polyester obtained above, an asphalt composition in which the domain part containing the polyester is highly dispersed in a matrix part containing the asphalt can be obtained. The breaking force means a force that causes the domain parts in the the matrix part to collide with a wall and break up, and which does not mean a shear force applied by a mixing blade and the like.

In applying a breaking force to the molten mixture, a domain part containing the polyester is refined and dispersed in the asphalt using a high-speed homogenizer to disperse the domain part containing the polyester in a matrix part containing the asphalt. The breaking force is applied in a such way that the number average longest diameter of the domain part containing the polyester becomes preferably ≤20 km. In the applying a breaking force to the molten mixture, from the viewpoints of the thermal stability of asphalt emulsion and the fuel resistance of asphalt pavement, the breaking force is applied so that the number average longest diameter of the domain part becomes more preferably ≤15 m, further preferably ≤10 μm.

The number average longest diameter of the domain part containing the polyester is measured, for example, by a method described in the section of Examples.

Note that the domain part containing the polyester cannot be refined and dispersed only by stirring with an anchor type impeller or the like.

The rotation number of the high-speed homogenizer in application of the breaking force is, from the viewpoints of the thermal stability of asphalt emulsion and the fuel resistance of asphalt pavement, preferably ≥800 rpm, more preferably ≥1,500 rpm, further preferably ≥2,000 rpm, and preferably ≤5,000 rpm, more preferably ≤4,500 rpm, further preferably ≤4,000 rpm.

The temperature in application of the breaking force is, from the viewpoints of the thermal stability of asphalt emulsion and the fuel resistance of asphalt pavement, the softening point of the polyester or higher, more preferably ≥140° C., further preferably ≥150° C., and from the viewpoint of preventing the degradation of the asphalt, preferably ≤200° C., more preferably ≤190° C., further preferably ≤180° C.

The time for application of the breaking force is not particularly limited, but, from the viewpoints of the thermal stability of asphalt emulsion and the fuel resistance of asphalt pavement, preferably ≥3 minutes, more preferably ≥10 minutes, further preferably ≥30 minutes, furthermore preferably ≥1 hour, and, from the viewpoint of preventing the degradation of the asphalt, preferably ≤8 hours, more preferably ≤6 hours, further preferably ≤5 hours, furthermore preferably ≤4 hours.

### [Asphalt Composition]

An asphalt composition according to the present invention is an asphalt composition containing a matrix part and a domain part, the matrix part containing an asphalt, the domain part containing a polyester, the domain part having a number average longest diameter of ≤20 m.

The asphalt composition is preferably an asphalt composition produced by the method described in the foregoing method for producing an asphalt composition.

Examples of the asphalt and the polyester contained in the asphalt composition include the asphalts and the polyesters mentioned in the foregoing method for producing an asphalt composition, and preferred ranges are also the same.

An asphalt composition according to the present invention that can be suitably used, for example, for a prime coat, a tack coat, and the like. The obtained asphalt composition can be used for producing a mixture for pavement by mixing with an aggregate, a filler, and the like.

### [Asphalt Emulsion]

An asphalt emulsion according to the present invention is obtained by dispersing particles containing the asphalt composition in an aqueous medium. The asphalt emulsion may further contain a surfactant, a polymer material, and the like.

### <Aqueous Medium>

The aqueous medium is a dispersion medium in which water occupies the most proportion by mass. The water content in the aqueous medium is, from the viewpoints of the thermal stability of asphalt emulsion and the fuel resistance of asphalt pavement, preferably ≥80% by mass, more preferably 90% by mass, further preferably 95% by mass, and preferably ≤100% by mass, more preferably 100% by mass.

Examples of components other than water include organic solvents that dissolve in water, for example, alkyl alcohols having ≥1 and ≤5 carbon atoms, such as methanol and ethanol; dialkyl ketones having 3 and ≤5 carbon atoms, such as acetone and methyl ethyl ketone; and a cyclic ether, such as tetrahydrofuran.

In one of preferred aspects of the asphalt emulsion, the aqueous medium is essentially constituted only of water.

The solid content in the asphalt emulsion is, from the viewpoints of the thermal stability of asphalt emulsion and the fuel resistance of asphalt pavement, preferably 20% by mass, more preferably ≥30% by mass, further preferably ≥40% by mass, and, from the viewpoint of the emulsifying ability, preferably ≤80% by mass, more preferably ≤75% by mass, further preferably 70% by mass. The aqueous medium is preferably added in such an amount that the solid content in the asphalt emulsion falls within the above range.

### <Surfactant>

Examples of the surfactant include a cationic surfactant, an anionic surfactant, an amphoteric surfactant, and a nonionic surfactant, and, from the viewpoint of emulsifying ability, the surfactant is preferably a cationic surfactant.

Examples of the cationic surfactant include a mineral acid salt or a lower carboxylic acid salt of an amine, such as an alkylamine, an alkylpolyamine, an amideamine, or an alkylimidazoline, a quaternary ammonium salt, and an alkylpyridinium chloride.

Into the cationic surfactant, in terms of the form of the surfactant, for example, for the purpose of making a liquid form, a solvent, such as water, a lower alcohol, glycol, and polyoxyethylene glycol, a saccharide, such as glucose and sorbitol, a lower fatty acid, a lower amine, a hydrotropic agent, such as p-toluenesulfonic acid and an ether carboxylic acid, or the like can be blended.

The content of the cationic surfactant is, in view of the economy and from the viewpoint of the thermal stability of the asphalt emulsion, relative to total mass of the asphalt emulsion, preferably ≥0.02% by mass, more preferably ≥0.05% by mass, further preferably ≥0.10% by mass, and preferably ≤3.0% by mass, more preferably ≤2.5% by mass, further preferably ≤2.0% by mass.

### <Polymer Material>

Examples of the polymer material include thermoplastic elastomers, such as a styrene/butadiene rubber (SBR), a styrene/butadiene/block copolymer (SBS), a styrene/isoprene/block copolymer (SIS), and an ethylene/vinyl acetate copolymer (EVA); and thermoplastic resins, such as an ethylene/vinyl acetate copolymer, an ethylene/ethyl acrylate copolymer, polyethylene, and polypropylene.

The content of the polymer material in the asphalt emulsion is, from the viewpoints of the fuel resistance and the in-water abrasion resistance of asphalt pavement, preferably ≥0.1% by mass, more preferably ≥0.5% by mass, further preferably ≥1% by mass, and preferably ≤10% by mass, more preferably ≤5% by mass, further preferably ≤3% by mass.

When the asphalt in the asphalt composition is polymer-modified with a thermoplastic elastomer, the content of the thermoplastic elastomer in the asphalt emulsion includes the amount of the thermoplastic elastomer derived from the asphalt composition.

### [Method for Producing Asphalt Emulsion]

The asphalt emulsion is preferably produced by a method of adding the asphalt composition containing the polyester to a mixture containing an aqueous medium and a surfactant and optionally containing a polymer material and the like (hereinafter also referred to as “optional components”) and mixing the asphalt composition and the mixture.

From the viewpoint of emulsification, the mixing is preferably performed with an emulsifying apparatus, such as a colloid mill, a barrel-type high-speed homogenizer, a high-speed homogenizer, and a line mixer.

The temperature of the mixture of an aqueous medium, a surfactant, and optional components in adding the asphalt composition is, from the viewpoint of the emulsification, preferably ≥25° C., more preferably ≥30° C., further preferably ≥35° C., and preferably ≤80° C., more preferably ≤55° C., further preferably ≤45° C.

The pH of the mixture of an aqueous medium, a surfactant, and optional components in adding the asphalt composition is, from the viewpoint of the emulsification, preferably ≥1, more preferably ≥1.5, further preferably ≥1.8, and preferably ≤2.5, more preferably ≤2.2, further preferably ≤2.0. In other words, the content of an acid in the asphalt emulsion is such an amount that gives a pH of the mixture of an aqueous medium, a surfactant, and optional components within the above range.

The temperature of the asphalt composition in addition thereof to the mixture of an aqueous medium, a surfactant, and optional components is, from the viewpoint of the emulsification, preferably ≥120° C., more preferably ≥125° C., further preferably ≥130° C., and preferably ≤180° C., more preferably ≤155° C., further preferably ≤150° C.

The volume average particle diameter of particles containing the asphalt composition in the asphalt emulsion is, from the viewpoints of the thermal stability of asphalt emulsion and the fuel resistance of asphalt pavement, preferably ≥0.1 m, more preferably ≥0.5 m, further preferably ≥0.8 m, and preferably ≤2.5 m, more preferably ≤2.0 m, further preferably ≤1.5 m.

According to the present invention, it is possible to provide an asphalt emulsion having a superior thermal stability and asphalt pavement having a superior fuel resistance.

### EXAMPLES

Various properties were measured and evaluated according to the methods described below.

In Examples and Comparative Examples below, parts and % are expressed by mass unless otherwise specified.

In Production Examples, Examples, and Comparative Examples below, “parts” and % are “parts by mass” and “% by mass” unless otherwise specified.

### (1) Method for Measuring Acid Value and Hydroxyl Value of Polyester

The acid value and the hydroxyl value of a polyester were measured based on JIS K0070:1992. However, only the measurement solvent was changed from a mixed solvent of ethanol and ether defined in JIS K0070:1992 to a mixed solvent of acetone and toluene (acetone:toluene=1:1 (by volume)) for polyesters 1 to 3 and to a mixed solvent of chloroform and dimethylformamide (chloroform:dimethylformamide=7:3 (by volume)) for polyesters 4 to 6.

### (2) Methods for Measuring Softening Point and Glass Transition Temperature of Polyester

### (i) Softening Point

Using a flow tester (“CFT-500D” manufactured by SHIMADZU CORPORATION), a load of 1.96 MPa was applied with a plunger to 1 g of a sample while heating the sample at a temperature increase rate of 6° C./minute to extrude the sample from a nozzle having a diameter of 1 mm and a length of 1 mm. The amount of descent of the plunger of the flow tester was plotted versus the temperature, and the temperature at the time when the half amount of the sample flowed out was taken as the softening point.

### (ii) Glass Transition Temperature

Using a differential scanning calorimeter (“Q-100” manufactured by TA Instruments Japan Inc.), 0.01 to 0.02 g of a sample was weighed into an aluminum pan, was heated to 200° C., and was then cooled from the temperature to 0° C. at a temperature decrease rate of 10° C./minute. Next, while increasing the temperature to 150° C. at a temperature increase rate of 10° C./minute, the calory was measured.

Among the observed endothermic peaks, the temperature of a peak having the largest peak area was taken as the endothermic maximum peak temperature. When no peak was observed but only a step was observed, the temperature of the point at which the tangential line having the maximum inclination of the curve in the step region intersects with the extension of the baseline on the lower temperature side of the step was taken as the glass transition temperature.

### (3) Method for Measuring Number Average Molecular Weight and Weight Average Molecular Weight of Polyester

The molecular weight distribution was measured by a gel permeation chromatography (GPC) method obtained by the following method to determine the number average molecular weight and the weight average molecular weight.

### (i) Preparation of Sample Solution

A sample was dissolved in a solvent at 25° C. at a concentration of 0.5 g/100 mL. Subsequently, the solution was filtered with a fluororesin filter having a pore size of 0.2 μm (“DISMIC-25JP” manufactured by TOYO ROSHI KAISHA, LTD.) to remove insoluble matter, thereby preparing a sample solution.

As for solvents, chloroform was used for polyesters 1 to 3 and tetrahydrofuran was used for polyesters 4 to 6.

### (ii) Measurement of Molecular Weight

The measurement apparatus and analytical column described below were used, and the same solvent as used for preparing the sample solution was allowed to flow as an eluent at a flow rate of 1 mL per minute to stabilize the column in a thermostat of 40° C. Into the column, 100 μL of the sample solution was injected to perform measurement. The molecular weight of the sample was calculated based on a calibration curve created in advance. Here, the calibration curve used was created using the following several monodisperse polystyrenes as standard samples: “A-500” (5.0×10²), “A-1000” (1.01×10³), “A-2500” (2.63×10³), “A-5000” (5.97×10³), “F-1” (1.02×10³), “F-2” (1.81×10⁴), “F-4” (3.97× 10⁴), “F-10” (9.64×10⁴), “F-20” (1.90×10⁵), “F-40” (4.27×10⁵), “F-80” (7.06×10⁵), “F-128” (1.09×10⁶) (all manufactured by TOSOH CORPORATION).
Measurement apparatus: “HLC-8220CPC” (manufactured by TOSOH CORPORATION)
Analytical column: “GMHXL”+“G3000HXL” (manufactured by TOSOH CORPORATION)
   (4) Method for measuring number average longest diameter of domain containing polyester in asphalt composition

Into an aluminum tube (diameter: 25 mm, length: 125 to 140 mm, conforming to ASTM D7173-14), 50 g of an asphalt composition which was stirred at 163° C. and 450 rpm for 1 minute was injected under a condition of 163° C. This asphalt composition was cooled to a room temperature and was stored at 0° C. for 4 hours. Then, the aluminum tube with the asphalt composition was equally divided into 3 parts with a pipe cutter, and the middle part was placed in an aluminum cup and was heated at 163° C. for 20 minutes to melt the asphalt composition, whereby the asphalt composition was taken out of the aluminum tube. The aluminum tube piece was removed from the aluminum cup, and the molten asphalt composition was quickly uniformly mixed with a metal spatula for 20 seconds. Immediately after the mixing, a very small amount of the molten asphalt composition was added dropwise onto an object slide with a wire having a tapered tip so that the molten product of the asphalt and polyester gave a diameter of about 0.2 mm and was quickly covered with a cover glass. Then, the object slide after sampling was heated for 60 seconds on a horizontal stage in an oven at 163° C. to prepare a sample having such a thickness that enabled observation with a microscope. In preparing the sample, any force other than the gravity was not applied on the cover glass to hardly cause transformation of the domain part containing the polyester of the asphalt composition. Twenty photographic images of the sample were taken using a transmission-type digital microscope (Digital Microscope VHX-1000 manufactured by KEYENCE CORPORATION) with a x250 lens so that the fields of view thereof did not overlap. The longest diameter of the largest particle domain in each image was measured, and the average diameter determined by taking the arithmetic mean of the obtained longest diameters of the twenty largest particle domains was taken as the longest diameter of the domain part containing the polyester of the asphalt composition.

### (5) Method for Measuring Volume Average Particle Diameter of Particles Containing Asphalt Composition in Asphalt Emulsion

Into a 100-mL beaker, 15 mL of deionized water was poured, and then, 0.2 mL of an asphalt emulsion was added thereto and was sufficiently stirred. The prepared diluted asphalt emulsion solution was put into a cell of a nano-particle diameter measurement apparatus (NANOTRAC WAVE II manufactured by MICROTRAC MRB) to fill the cell. After confirming indication of “Detectable Concentration” on a display of the nano-particle diameter measurement apparatus, measurement with a dynamic light scattering (DLS) analyzer was started to measure the volume average particle diameter of the particles containing the asphalt composition.

### (6) Method for Measuring Longest Diameter of Particles Containing Asphalt Composition in Asphalt Emulsion

Into a 5-mL sample bottle containing about 4 g of deionized water, about 0.4 g of an asphalt emulsion was added dropwise with a spuit, and was sufficiently mixed to prepare a diluted asphalt emulsion solution. One drop of the diluted solution was added onto an object slide, and was covered with a cover glass so slowly as to take no air bubble. Any force other than the gravity was not applied onto the cover glass to hardly cause transformation of the particles containing the asphalt composition in the asphalt emulsion. Using a transmission-type digital microscope (Digital Microscope VHX-1000 manufactured by KEYENCE CORPORATION) with a x250 lens, five images were taken so that the fields of view thereof did not overlap. Then, the average of the largest diameters of the particles containing the asphalt composition in the fields of view was determined and was taken as the longest diameter of the particles containing the asphalt composition.

### (7) Method for Evaluating Fuel Resistance of Asphalt Emulsion

In a mixing bowl, 800 g of an aggregate (Type II manufactured by Gordonville, water content: 3% by weight) that passed through a sieve of No. 4 (4.75 mm) and 5.8 g of a cement were sufficiently mixed. To the mixture, 23.2 g of water was added, and mixed until the entire mixture became uniform. To the mixture, 93.1 g of an asphalt emulsion was added and was mixed for 30 seconds until the entire mixture became uniform, and the mixture was quickly casted into the upper half of a mold. Within 15 seconds after the casting of the mixture in the mold, the mixture was molded with a mold strike off apparatus. After the mold was slowly released, the molded product was stored in an oven set at 60° C. for ≥15 hours and ≤30 hours for drying. The molded product was taken out of the oven, and the temperature of the molded product was cooled down to a room temperature (25° C.), thus producing a sample having a diameter of 10 inches and a thickness of ¼ inches. Under a room temperature, the sample was slowly placed in a container in which kerosene was previously poured to a height of about 2 inches, and the sample was immersed in the kerosene for 15 minutes. The sample was taken out from the kerosene and dried using a fun at a room temperature for 48 hours. The mass of the dried sample was recorded as an initial mass. The sample was set onto a pan of an abrasion tester (Benedict Wet Track Abrasion Tester N-50 manufactured by Berglamp) by clipping. An abrasion test was performed with a rotation speed of a rubber tube in a lower part of a roller of the abrasion tester set to the lowest speed. After 2 minutes, the rotation of the rubber tube was stopped, the sample was taken out, and a part disrupted was removed with a brush. The mass of the abrased sample was taken as an abrased mass, and the proportion of the mass reduction relative to the initial mass was taken as a mass loss (% by mass). A lower mass loss indicates a better fuel resistance.

### (8) Method for Measuring High Temperature Storage Stability of Asphalt Emulsion

Into a cylinder, 500 mL of an asphalt emulsion was measured, and was stored in an oven at 40° C. for 24 hours. Then, 50 mL of an upper part and 50 mL of a lower part of the asphalt emulsion in the cylinder were each poured into a 200-mL beaker and the weights thereof were measured, and the weight of 50 mL of the upper part of the asphalt emulsion was represented by Wt and the weight of 50 mL of the lower part of the asphalt emulsion was represented by Wb. Subsequently, a glass mixing rod was placed in each beaker and the entire mass of the beaker was measured. The weight of the beaker containing the upper part of the asphalt emulsion was represented by Wti and the weight of the beaker containing the lower part of the asphalt emulsion was Wbi. While storing each beaker in the oven at 163° C. for 3 hours, the beaker was stirred with a glass rod once about 30 minutes to prevent lumping. Each beaker was taken out of the oven and was cooled down to a room temperature, and the mass of the beaker was measured. The weight of the beaker containing the upper part of the asphalt emulsion was represented by Wte and the weight of the beaker containing the lower part of the asphalt emulsion was represented by Wbe. Based on the following formula, the value indicating the high temperature stability was represented by D. Alarger absolute value of D shows a larger difference between the amounts of water vaporized from the upper part of the asphalt emulsion and from the lower part of the asphalt emulsion. A smaller absolute value of D means a superior high temperature stability of the asphalt emulsion.

$$D = 100 \times [ \{ ( W t e - W ti ) / Wt \} - ( W b e - Wbi / W b \} ]$$

### [Production of Polyester]

### Production Example 1 (Production of Polyester 1)

A polyoxypropylene(2.2) adduct of bisphenol A, terephthalic acid, and polyethylene terephthalate (manufactured by UNIFI, 100% Post Consumer rPET Resin | 500 Mesh Filtered Round | Bright 10.68 IV | Crystallized) which are shown in Table 1 were put in a 10-L four-neck flask equipped with a nitrogen introducing pipe, a dewatering conduit, a stirrer, a thermometer, and a thermocouple, and were heated to 120° C. An esterification catalyst and an esterification promoter which are shown in Table 1 were put at 120° C. and then, the temperature was quickly increased to 235° C. Then, while keeping the temperature at 235° C. for 4 hours, the reaction system was thoroughly stirred. After a reaction for 4 hours, the temperature was decreased to 185° C. Then, dodecenylsuccinic anhydride shown in Table 1 was put, and the temperature was increased to 220° C. at 10° C./30 minutes. The mixture was then reacted at 220° C. and 100 torr for about 2 hours until the softening point shown in Table 1 was achieved to thus produce a polyester 1. The polyester 1 was evaluated by the evaluation methods as described above. The results are shown in Table 1.

### Production Example 2 (Production of Polyester 2)

A polyester 2 was produced in the same manner as in Production Example 1 except for changing the raw materials of the polyester and the amounts thereof to those shown in Table 1. The polyester 2 was evaluated by the evaluation methods as described above. The results are shown in Table 1.

### Production Example 3 (Production of Polyester 3)

A polyester 3 was produced in the same manner as in Production Example 1 except for changing the raw materials of the polyester and the amounts thereof to those shown in Table 1. The polyester 3 was evaluated by the evaluation methods as described above. The results are shown in Table 1.

### Production Example 4 (Production of Polyester 4)

A polyoxypropylene(2.2) adduct of bisphenol A, terephthalic acid, and polyethylene terephthalate (manufactured by UNIFI, 100% Post Consumer rPET Resin | 500 Mesh Filtered Round | Bright 10.68 IV | Crystallized) which are shown in Table 1 were put in a 10-L four-neck flask equipped with a nitrogen introducing pipe, a dewatering conduit, a stirrer, a thermometer, and a thermocouple, and were heated to 160° C. to dissolve the components. Raw monomers of the addition polymer segment containing butyl acrylate and 4-tert-butylcatechol shown in Table 1 were added dropwise with a dropping funnel over 1 hour while keeping the temperature of the reaction system at 160° C.±3° C. Stirring was continued for 1 hour while keeping the temperature at 160° C. to polymerize the raw monomers. Then, the resultant was stirred at 8.3 kPa for 1 hour to remove unreacted raw monomers of the addition polymer segment. Then, tin (II) 2-ethylhexanoate was added, the temperature was increased to 230° C. and was kept for 8 hours, and then, was decreased to 185° C. Dodecenylsuccinic anhydride was put at 185° C., and the temperature was increased to 220° C. at 10° C./30 minutes. Then, the mixture was reacted at 220° C. and 100 torr for about 3 hours until the softening point shown in Table 1 was achieved, thus producing a polyester 4. The polyester 4 was evaluated by the evaluation methods as described above. The results are shown in Table 1.

### Production Example 5 (Production of Polyester 5)

Alcohol components and carboxylic acid components other than trimellitic anhydride which are shown in Table 1 were put in a 10-L four-neck flask equipped with a nitrogen introducing pipe, a dewatering conduit, a stirrer, a thermometer, and a thermocouple, and were heated to 160° C. to dissolve the components. Raw monomers of the addition polymer segment containing acrylic acid and 4-tert-butylcatechol which are shown in Table 1 were added dropwise with a dropping funnel over 1 hour while keeping the temperature of the reaction system at 160° C.±3° C. Stirring was continued for 1 hour while keeping the temperature at 160° C. to polymerize the raw monomers and acrylic acid, and then, the resultant was stirred at 8.3 kPa for 1 hour. Then, tin (II) 2-ethylhexanoate was added, the temperature was increased to 230° C. and was kept for 6.5 hours, and a reaction was continued at 230° C. under a reduced pressure at 8.3 kPa for 1 hour. Then, trimellitic anhydride was put at 215° C., and the mixture was reacted at 210° C. and 40 kPa until the softening point shown in Table 1 was achieved, thus producing a polyester 5. The polyester 5 was evaluated by the evaluation methods as described above. The results are shown in Table 1.

### Production Example 6 (Production of Polyester 6)

Alcohol components, carboxylic acid components other than fumaric acid and trimellitic anhydride, and a wax having a hydroxy group and a carboxy group (Paracol 6490 manufactured by NIPPON SEIRO, CO., LTD.) which are shown in Table 1 were put in a 10-L four-neck flask equipped with a nitrogen introducing pipe, a dewatering conduit, a stirrer, a thermometer, and a thermocouple, and were heated to 160° C. to dissolve the components. Raw monomers of the addition polymer segment containing acrylic acid and 4-tert-butylcatechol shown in Table 1 were added dropwise with a dropping funnel over 1 hour while keeping the temperature of the reaction system at 160° C.±3° C. Stirring was continued for 1 hour while keeping the temperature at 160° C. to polymerize the raw monomers and acrylic acid, and then, the resultant was stirred at 8.3 kPa for 1 hour. Then, tin (II) 2-ethylhexanoate and gallic acid were put, the temperature was increased to 235° C., and a reaction was conducted at a normal pressure for 6 hours, followed by a reaction at 235° C. under a reduced pressure at 8.3 kPa for 1 hour. Then, 4-tert-butylcatechol, fumaric acid, and trimellitic anhydride were added at 215° C., and the mixture was reacted at 210° C. and 40 kPa until a target softening point was achieved, thus producing a polyester 6. The polyester 6 was evaluated by the evaluation methods as described above. The results are shown in Table 1.

TABLE 1

| | | | Production Example | | | | | | |
|---|---|---|---|---|---|---|---|---|---|
| | | | 1 | | 2 | | 3 | | 4 |
| | | | Polyester | | | | | | |
| | | | 1 | | 2 | | 3 | | 4 |
| | | | Charged | Molar | Charged | Molar | Charged | Molar | Charged |
| | | | amount | ratio | amount | ratio | amount | ratio | amount |
| | | | (g) | *6 | (g) | *6 | (g) | *6 | (g) |
| Raw material of | Alcohol | BPA-PO Adduct *1 | 3517 | 40 | 3598 | 40 | 3572 | 40 | 2814 |
| polyester segment | component | BPA-EO Adduct *2 | 0 | 0 | 0 | 0 | 0 | 0 | 0 |
| | Carboxylic acid | Terephthalic acid | 984.2 | 23.6 | 1067 | 25 | 773 | 18.24 | 787 |
| | component | Fumaric acid | 0 | 0 | 0 | 0 | 0 | 0 | 0 |
| | | Adipic acid | 0 | 0 | 375 | 10 | 0 | 0 | 0 |
| | | Dodecenylsuccinic anhydride | 604.5 | 9.4 | 0 | 0 | 470 | 7.2 | 484 |
| | | Trimellitic anhydride | 0 | 0 | 0 | 0 | 245 | 5 | 0 |
| | Wax *3 | | 0 | 0 | 0 | 0 | 0 | 0 | 0 |
| | Polyethylene terephthalate | | 2894.0 | 60 | 2961.0 | 60 | 2940.0 | 60 | 2315.0 |
| Bireactive monomer | | Acrylic acid | 0 | 0 | 0 | 0 | 0 | 0 | 0 |
| | | Butyl acrylate | 0 | 0 | 0 | 0 | 0 | 0 | 620.0 |
| Raw material of addition | Raw material | Styrene | 0 | 0 | 0 | 0 | 0 | 0 | 929.0 |
| polymer segment | monomer | 2-Ethylhexyl acrylate | 0 | 0 | 0 | 0 | 0 | 0 | 0 |
| | | Stearyl methacrylate | 0 | 0 | 0 | 0 | 0 | 0 | 0 |
| | Radical | Di-tert- | 0 | 0 | 0 | 0 | 0 | 0 | 56.0 |
| | polymerization | butylperoxide | | | | | | | |
| | initiator | | | | | | | | |

| PET Ratio (% by mass)*4 | | 36% | | 37% | | 37% | | 29% |
|---|---|---|---|---|---|---|---|---|
| BPA Alkylene adduct ratio (% by mass)*5 | | 44% | | 45% | | 44% | | 35% |
| | | Charged | Mass | Charged | Mass | Charged | Mass | Charged |
| | | amount | ratio | amount | ratio | amount | ratio | amount |
| | | (g) | *7 | (g) | *7 | (g) | *7 | (g) |
| Esterification catalyst | Tin (II) di(2-ethylhexanoate) | 40.0 | 0.5 | 25.0 | 0.3 | 40.0 | 0.5 | 32.0 |
| Esterification promoter | Gallic acid | 4.2 | 0.1 | 0 | 0 | 0 | 0 | 0 |
| Radical polymerization | 4-tert-Butylcatechol | 0 | 0 | 0 | 0 | 0 | 0 | 0 |
| inhibitor | | | | | | | | |

| | | | | | |
|---|---|---|---|---|---|
| Properties | Softening point /Tm (° C.) | 103 | 103 | 117 | 102 |
| | Glass transition temperature /Tg (° C.) | 59 | 56 | 63 | 52 |
| | Acid value (mgKOH/g) | 7 | 9 | 7 | 7 |
| | Hydroxyl value (mgKOH/g) | 26 | 22 | 29 | 20 |
| | Number average molecular weight Mn | 3,100 | 3,200 | 4,000 | 3,000 |
| | Weight average molecular weight Mw | 8,500 | 9,000 | 26,000 | 27,000 |

| | | | Production Example | | | | |
|---|---|---|---|---|---|---|---|
| | | | 4 | 5 | | 6 | |
| | | | Polyester | | | | |
| | | | 4 | 5 | | 6 | |
| | | | Molar | Charged | Molar | Charged | Molar |
| | | | ratio | amount | ratio | amount | ratio |
| | | | *6 | (g) | *6 | (g) | *6 |
| Raw material of | Alcohol | BPA-PO Adduct *1 | 40 | 3271 | 70 | 3318 | 100 |
| polyester segment | component | BPA-EO Adduct *2 | 0 | 1302 | 30 | 0 | 0 |
| | Carboxylic acid | Terephthalic acid | 23.6 | 1020 | 46 | 1023 | 65 |
| | component | Fumaric acid | 0 | 0 | 0 | 132 | 12 |
| | | Adipic acid | 0 | 0 | 0 | 0 | 0 |
| | | Dodecenylsuccinic anhydride | 9.4 | 615 | 18 | 0 | 0 |
| | | Trimellitic anhydride | 0 | 564 | 22 | 218 | 12 |
| | Wax *3 | | 0 | 0 | 0 | 371.0 | 3.9 |
| | Polyethylene terephthalate | | 60 | 0 | 0 | 0 | 0 |
| Bireactive monomer | | Acrylic acid | 0 | 29.0 | 3.0 | 109.0 | 16.0 |
| | | Butyl acrylate | 4.8 | 0 | 0 | 0 | 0 |
| Raw material of addition | Raw material | Styrene | 8.9 | 882.0 | 8.5 | 1592.0 | 15.3 |
| polymer segment | monomer | 2-Ethylhexyl acrylate | 0 | 168.0 | 0.9 | 0 | 0 |
| | | Stearyl methacrylate | 0 | 0 | 0 | 1061.0 | 3.1 |
| | Radical | Di-tert- | 0.4 | 84.0 | 0.6 | 318.0 | 3.1 |
| | polymerization | butylperoxide | | | | | |
| | initiator | | | | | | |

| PET Ratio (% by mass)*4 | | 29% | 0% | | 0% | |
|---|---|---|---|---|---|---|
| BPA Alkylene adduct ratio (% by mass)*5 | | 35% | 57% | | 41% | |
| | | Mass | Charged | Mass | Charged | Mass |
| | | ratio | amount | ratio | amount | ratio |
| | | *7 | (g) | *7 | (g) | *7 |
| Esterification catalyst | Tin (II) di(2-ethylhexanoate) | 0.5 | 34.0 | 0.5 | 24.0 | 0.5 |
| Esterification promoter | Gallic acid | 0 | 0 | 0 | 1.4 | 0.03 |
| Radical polymerization | 4-tert-Butylcatechol | 0 | 0 | 0 | 1.0 | 0.02 |
| inhibitor | | | | | | |

| | | | | |
|---|---|---|---|---|
| Properties | Softening point /Tm (° C.) | 102 | 112 | 122 |
| | Glass transition temperature /Tg (° C.) | 52 | 60 | 53 |
| | Acid value (mgKOH/g) | 7 | 24 | 14 |
| | Hydroxyl value (mgKOH/g) | 20 | 28 | 19 |
| | Number average molecular weight Mn | 3,000 | 2,360 | 4,130 |
| | Weight average molecular weight Mw | 27,000 | 46,200 | 15,300 |

*1: BBA-PO Adduct: polyoxypropylene(2.2) adduct of bisphenol A
*2: BPA-EO Adduct: polyoxyethylene(2.2) adduct of bisphenol A
*3: Wax: modified wax having hydroxy group and carboxy group (Paracol 6490 manufactured by NIPPON SEIRO CO., LTD.)
*4: Proportion of mass of polyethylene terephthalate relative to total of masses of all raw materials of polyester
*5: Sum of masses of BPA-PO and BPA-EO relative to total of masses of all raw materials of polyester
*6: Molar ratio relative to total of alcohol comwnent and ethylene glycol units in PET taken a 100
*7: Proportion of mass relative to total of masses of all raw material of polyester

### [Production of Asphalt Composition]

### Example 1-1 (Production of Asphalt Composition 1)

A ¼-gallon paint can containing 600 g of an asphalt (PG 64-22 manufactured by Associated Asphalt) was heated in an oven at 163° C. for a minimum time (about 2 hours) until the entire asphalt had a uniform viscosity. Then, the paint can was removed out of the oven and set to a high-speed homogenizer (L4R manufactured by SILVERSON). While mixing at 3000 rpm with temperature controlled at 165 to 175° C., 18 g of the polyester 1 in a powder form was slowly sifted in over about 1 minute to the asphalt. After polyester 1 addition, the mixture was stirred at about 165 to 175° C. and 3000 rpm for 2 hours, thus producing the asphalt composition 1. The longest diameter of the domain containing the polyester in the asphalt composition 1 was evaluated by the method described above. The result is shown in Table 2.

### Examples 1-2 to 1-7 (Production of Asphalt Compositions 2 to 7)

Asphalt compositions 2 to 7 were produced in the same manner as in Example 1-1 except for using the polyester shown in Table 2. The largest diameter of the domain containing the polyester in each of the asphalt compositions 2 to 7 was evaluated by the method described above. The result is shown in Table 2.

### Example 1-8 (Production of Asphalt Composition 8)

The asphalt composition 8 was produced in the same manner as in Example 1-1 except for adding 3 g of a cationic surfactant (Asfier N480L manufactured by KAO CORPORATION) to the asphalt stirred at 3000 rpm before adding the polyester 1. The largest diameter of the domain containing the polyester in the asphalt composition 8 was evaluated by the method described above. The result is shown in Table 2.

### Comparative Example 1-1 (Production of Asphalt Composition C1)

The asphalt composition C1 was produced in the same manner as in Example 1-1 except for using an anchor type impeller at 300 rpm instead of high-speed homogenizer. The largest diameter of the domain containing the polyester in the asphalt composition C1 was evaluated by the method described above. The result is shown in Table 2.

TABLE 2

| | | | | Cationic | | | |
|---|---|---|---|---|---|---|---|
| | | Asphalt | Polyester | surfactant | Mixing condition | | Largest |
| | Asphalt | (parts by | (parts by | *2 (parts | Mixing | Stirring | diameter of |
| | composition | mass)*1 | mass)*1 | by mass) *1 | apparatus | speed (rpm) | domain (nm) |
| Example 1-1 | 1 | 100 | 1 (3) | — | Homogenizer | 3,000 | 6 |
| Example 1-2 | 2 | 100 | 2 (3) | — | Homogenizer | 3,000 | 10 |
| Example 1-3 | 3 | 100 | 3 (3) | — | Homogenizer | 3,000 | 8 |
| Example 1-4 | 4 | 100 | 4 (3) | — | Homogenizer | 3,000 | 5 |
| Example 1-5 | 5 | 100 | 5 (3) | — | Homogenizer | 3,000 | 5 |
| Example 1-6 | 6 | 100 | 1 (2) | — | Homogenizer | 3,000 | 4 |
| | | | 5 (1) | | | | |
| Example 1-7 | 7 | 100 | 1 (2) | — | Homogenizer | 3,000 | 4 |
| | | | 6 (1) | | | | |
| Example 1-8 | 8 | 100 | 1 (3) | 0.5 | Homogenizer | 3,000 | 4 |
| Comparative | C1 | 100 | 1 (3) | — | Anchor type | 300 | 250 |
| Example 1-1 | | | | | impeller | | |

*1: Parts by mass relative to 100 parts by mass of asphalt
*2: Asfier N480L manufactured by KAO CORPORATION

### [Production of Asphalt Emulsion]

### Example 2-1 (Production of Asphalt Emulsion 1)

A soap colustion was prepared in a 600-mL beaker by adding 370 g of water and heated to 40° C. to 50° C. Then, the beaker was placed on a hot plate, and while keeping the temperature at 40° C. to 50° C., 15 g of a cationic surfactant (Asfier N480L manufacture by KAG CORPORATION) and 15 g of hydrochloric acid were incorporated. The mixture was stirred with a magnetic stiffer until the cationic surfactant was uniformly dissolved. After the cationic surfactant dissolved, an SBR emulsion (UP1159 manufactured by ULTRAPAVE, solid concentration: 65% by mass) was added as a thermoplastic elastomer and stirring was continued. After achieving a uniform state, the pH of the aqueous dispersion was measured, and hydrochloric acid was added as needed to adjust the pH into 1.8 to 2.0. The magnetic stirrer was removed, and the resultant was used as a soap solution.

Into a circulation type colloid mill (manufactured by ALPHA Laboratory Equipment), the surfactant solution was poured, and the switch of the colloid mill was turned on to circulate the soap solution, and 604 g of the asphalt composition 1 heated to 140° C. was poured over about 1 minute. Then, the mixture was mixed with the colloid mill for 2 minutes to 2.5 minutes and then cooled down to room temperature, thus producing an asphalt emulsion 1 having a solid concentration of 62% by mass. The largest diameter of particles containing the asphalt composition in the asphalt emulsion 1, the high temperature storage stability of the asphalt emulsion 1, and the fuel resistance of asphalt pavement constructed with the asphalt emulsion 1 were evaluated by the methods described above. The results are Table 3.

### Examples 2-2 to 2-8 and Comparative Example 2-1 (Production of Asphalt Emulsions 2 to 8 and C1)

Asphalt emulsions 2 to 8 and an asphalt emulsion C1 were produced in the same manner as in Example 2-1 except for changing the asphalt composition 1 to the asphalt composition shown in Table 3. The largest diameter of particles containing the asphalt composition in each asphalt emulsion, the high temperature storage stability of each asphalt emulsion, and the fuel resistance of asphalt pavement constructed with each asphalt emulsion were evaluated by the methods described above. The results are shown in Table 3.

### Comparative Example 2-2 (Production of Asphalt Emulsion C2)

An asphalt emulsion C2 was produced in the same manner as in Example 2-1 except for chancing the asphalt composition 1 to an asphalt (PG 64-22 manufactured by Associated Asphalt). The largest diameter of particles containing the asphalt composition in the asphalt emulsion C2, the high temperature storage stability of the asphalt emulsion C2, and the fuel resistance of asphalt pavement constructed with the asphalt emulsion C2 were evaluated by the methods described above. The results are shown in Table 3.

TABLE 3

| | | Largest | Fuel | High |
|---|---|---|---|---|
| | | diameter of | resistance | temperature |
| | Asphalt | particles | (mass | storage |
| | composition | (μm) *1 | loss %) | stability (D) |
| Example | 1 | 3 | 5 | 0.9 |
| 2-1 | | | | |
| Example | 2 | 5 | 8 | 1.0 |
| 2-2 | | | | |
| Example | 3 | 3 | 10 | 0.9 |
| 2-3 | | | | |
| Example | 4 | 2 | 13 | 1.8 |
| 2-4 | | | | |
| Example | 5 | 1 | 25 | 3.9 |
| 2-5 | | | | |
| Example | 6 | 1 | 11 | 2.1 |
| 2-6 | | | | |
| Example | 7 | 1 | 12 | 2.3 |
| 2-7 | | | | |
| Example | 8 | 1 | 3 | 0.2 |
| 2-8 | | | | |
| Comparative | C1 | 2 | ND *3 | 4.5 |
| Example | | | | |
| 2-1 | | | | |
| Comparative | PG64-22 *2 | 80 | ND *3 | 15.0 |
| Example | | | | |
| 2-2 | | | | |

*1: Longest diameter of particles containing asphalt composition
*2: Asphalt (PG64-22) was used
*3: Unmeasurable due to breakage of sample

It can be seen in Table 3 that the asphalt emulsions 1 to 8 containing the asphalt compositions 1 to 8 obtained by the method for producing an asphalt composition according to the present invention are superior in the thermal stability, and that asphalt pavement constructed with the asphalt emulsions 1 to 8 has a superior fuel resistance.

On the other hand, the asphalt emulsion C1 of Comparative Example 2-1 obtained by using the asphalt composition C1 containing a melt-kneaded product of an asphalt and a polyester produced without a breaking force and the asphalt emulsion C2 of Comparative Example 2-2 obtained by using an asphalt in place of the asphalt composition were inferior in the thermal stability, and the asphalt pavement constructed with the asphalt emulsions C1 and C2 had a very low fuel resistance.

1. A method for producing an asphalt composition that contains a matrix part containing an asphalt and a domain part containing a polyester, the method comprising
melting the polyester in the asphalt to produce a molten mixture, and
applying a breaking force to the molten mixture.

2. The method for producing an asphalt composition according to claim 1, wherein in applying the breaking force to the molten mixture, a high-speed homogenizer is used.

3. An asphalt composition comprising a matrix part and a domain part,
the matrix part containing an asphalt, the domain part containing a polyester,
the domain part having a number average longest diameter of ≤20 μm.

4. The method for producing an asphalt composition according to claim 2, wherein a rotation number of the high-speed homogenizer in application of the breaking force is ≥800 rpm and ≤5,000 rpm.

5. The method for producing an asphalt composition according to claim 1, wherein a temperature in application of the breaking force is a softening point of the polyester or higher.

6. The method for producing an asphalt composition according to claim 1, wherein a time in application of the breaking force is ≥3 minutes and ≤8 hours.

7. The method for producing an asphalt composition according to claim 1, wherein a mass ratio of the polyester to the asphalt (polyester/asphalt) is ≥0.5/100 and ≤15/100.

8. An asphalt emulsion in which particles containing the asphalt composition produced by the method according to claim 1 are dispersed in an aqueous medium.

9. The asphalt emulsion according to claim 8, wherein a water content in the aqueous medium is ≥80% by mass and ≤100% by mass.

10. The asphalt emulsion according to claim 8, wherein a solid content in the asphalt emulsion is ≥20% by mass and ≤80% by mass.

11. The asphalt emulsion according to claim 8, comprising a cationic surfactant.

12. The asphalt emulsion according to claim 11, wherein a content of the cationic surfactant relative to total mass of the asphalt emulsion is ≥0.02% by mass and ≤3.0% by mass.

13. The asphalt emulsion according to claim 11, wherein the cationic surfactant is at least one selected from a mineral acid salt and a lower carboxylic acid salt of an amine, such as an alkylamine, an alkylpolyamine, an amideamine, and an alkylimidazoline, and a quaternary ammonium salt.

14. The asphalt emulsion according to claim 8, wherein a volume average particle diameter of the particles is ≥0.1 m and ≤2.5 μm.

15. A method for producing an asphalt emulsion, comprising adding the asphalt composition produced by the method according to claim 1 to a mixture containing an aqueous medium and a surfactant and optional component and mixing them.

16. The method for producing an asphalt emulsion according to claim 15, wherein, in adding the asphalt composition, a temperature of the mixture is ≥25° C. and ≤80° C., and a pH of the mixture is ≥1 and ≤2.5, and
a temperature of the asphalt composition is ≥120° C. and ≤180° C.

17. The method for producing an asphalt composition according to claim 1, wherein a number average molecular weight Mn of the polyester is ≥1,500 and ≤9,000.

18. The method for producing an asphalt composition according to claim 1, wherein the polyester comprises an ethylene glycol-derived structural unit and a terephthalic acid-derived structural unit that are derived from polyethylene terephthalate.

19. The method for producing an asphalt composition according to claim 18, wherein an amount of polyethylene terephthalate present in the raw materials is ≥5% by mass and ≤80% by mass in a total amount of the polyethylene terephthalate, the alcohol component, and the carboxylic acid component.

20. The method for producing an asphalt composition according to claim 18, wherein an alkylene oxide adduct of bisphenol Ain an alcohol component is ≥20% by mass and ≤80% by mass.
